(19) United States
(12) Patent Application Publication
(10) Pub. No.: US 2016/0108591 A1
(43) Pub. Date: Apr. 21, 2016

(54) ROAD MARKING

(71) Applicant: HEIJMANS N.V., Rosmalen (NL)

(72) Inventors: Josephus Cornelis Petrus Heerkens, KH Berlicum (NL); Johan Henk Goris, MN Utrecht (NL); Vincent Hendrikus Arnoldus DE WAAL, AG Delft (NL); Michiel Peters, LH Sint-michiels-gestel (NL); Petrus Ronaldus George Theodorus Martherus, JM's Hertogenbosch (NL)

(21) Appl. No.: 14/786,886

(22) PCT Filed: Apr. 23, 2014
(86) PCT No.: PCT/NL2014/050261

§ 371 Date: Oct. 23, 2015

(30) Foreign Application Priority Data
Apr. 24, 2013 (NL) 2010700
Nov. 18, 2013 (NL) 2011813
Dec. 20, 2013 (NL) 2011997
Apr. 1, 2014 (NL) 2012542

(51) Int. Cl. E01C 17/00; F21V 9/16; F21V 23/04; E01C 23/02

(52) U.S. Cl. CPC E01F 9/053; E01F 9/042; E01F 9/044; E01C 17/00; E01C 23/025; E01C 23/028; F21V 9/16; F21V 23/04; F21V 23/0464; F21W 2111/02

(57) ABSTRACT

The present invention relates to a road marking comprising a profile comprising a luminescent component, which is to be installed in the road surface, in which profile one or more light sources are present and the aforesaid luminescent component is located above said one or more light sources. The profile is made of an elastic material, wherein the part of the profile present at the surface of the road surface is translucent.

The present invention relates to a road marking comprising a layer comprising a luminescent component, which is to be installed in or on the road surface, in which layer one or more light sources are present. The aforesaid luminescent component is located above said one or more light sources. The present invention further relates to a road surface which comprises one or more road markings according to the present invention.

Roads on which cars and trucks travel must meet a number of safety requirements. An important element thereof is the road marking, for example in the form of lines, stripes and strips. Thus there are a multitude of road markings which each represent specific information. In the Dutch province of Zeeland, for example, continuous border lines are used to signify a maximum speed of 100 km/h, for example. In addition to that, a continuous centre line signifies that overtaking is not permitted. Furthermore, a so-called “green filling” in the centre is used, which marking emphasizes that a speed of 100 km/h is permitted. Road markings can therefore be regarded as signs present on the road surface, which guide the traffic by means of visual information. Road markings comprise, inter alia, arrows, stripes, continuous and interrupted lines, but also so-called “shark's teeth” (give-way road marking). Road markings function not only to guide, but may also function as information sources, in particular in order to embellish the paving on which the markings are provided. Examples include, inter alia: city beautification, land art, artistic expressions, publicity, encouragement signs and the like.

In order to make the aforesaid road marking visible to the user also in the dusk, a luminescent component or also a light-reflecting material, such as glass beads, is added to the road marking in certain applications, which latter component lights up after it has been irradiated by a headlight of a car. Once the car has passed a particular position, however, the luminous effect of the road marking will die out, so that the road marking will not (not longer) be visible to traffic that will subsequently pass. A luminescent component absorbs energy from daylight during the daytime, which effect is stronger when the sun shines. The “charging” effect of a headlight of a car is small, however, on account of the low energy content of the light source. In addition to that, the irradiation time of such a headlight is short, because the car is travelling on the road and thus keeps irradiating new points of the road marking. The result is that after some time the marking is no longer visually perceptible in a dusky or nightly situation, not even if a luminescent component is used.

From European publication EP 0 422 694 there is known a road marking in which a light source is installed, which light source controlled by a photosensitive cell, which cells is activated by being irradiated by a headlight of a car, for example.

From Swedish publication SE 468946 there is furthermore known a road marking in the form of a paint powder, to which paint powder specific components have been added so as to make the road marking visible in the darkness, in particular when irradiated with UVA light.

From Dutch patent NL 1010856 there is known a road surface wherein a horizontal indicator is present in or on the road surface, which indicator can be switched by active switching means to make the indicator visible or invisible to the driver of a vehicle travelling on the road.

From US application US 2007/0223996 there is known a so-called road marker wherein the road marker has the following layer structure: an adhesive layer, a layer which comprises a rechargeable lithium battery, a layer which comprises an electronic circuit, a layer which comprises a reflecting metal layer, a layer which comprises an electroluminescent film and, finally, a layer which comprises a transparent protective film.

From European publication EP 0 658 655 there is known a road marker wherein LED's are embedded in a resin, which resin may be mixed with a phosphorescent material that is capable of emitting light.

US patent application US 2012/301657 relates to a road marker wherein the photoluminescent material present therein emits light after being irradiated with sunlight, artificial light or light from passing cars.

International application WO 2013/017410 relates to a road marker comprising an electrically conductive electrode applied to a carrier layer, a dielectric layer applied to the electrode, a light-emitting layer applied to the dielectric layer, an electrically conductive, translucent electrode applied to the light-emitting layer and, finally, a translucent protective layer provided with a reflecting layer.

The object of the present invention is to provide a road marking which, in dusky or nightly situations, is visible to road users, for example pedestrians and cyclists, but also drivers of vehicles travelling on the road, which term vehicles is to be understood to include cars, trucks, buses or, for example, motorcycles.

Another object of the present invention is to provide a road marking which is visible to road users in dusky or nightly situations, which road marking is installed so that there will be no undesirable elevations or recesses on or in the road surface.

Yet another object of the present invention is to provide a road marking which is marketed as a prefabricated product, which road marking can be installed in the road surface and, if desired, be removed therefrom in a simple manner.

The road marking as described in the introduction is characterised in that the profile is made of an elastic material, wherein the part of the profile present at the surface of the road surface is translucent.

One or more of the above objects are achieved by using the present road marking. Due to the special use of the profile made of an elastic material, which comprises both a luminescent component and one or more light sources, a so-called prefabricated product is obtained which can be installed in a road surface in a simple manner. The profile also prevents the ingress of moisture, so that the risk of a short-circuit is reduced, which considerably extends the life of the road marking. It is also possible to simply remove the profile made of an elastic material from the road surface and replace it by another road marking without causing damage to the road surface. Providing the road marking in the form of a prefabricated product makes it possible to produce the products elsewhere in advance and transport them to the site where they are to be used. Thus, the prefab products can be subjected to an adequate quality inspection in advance, thereby preventing situations in which road markings are installed which subsequently appear not to function, for example due to a short-circuit.

The luminescent component that is present in the road marking will only emit light after it has previously been irradiated with light. The intensity of the light emitted by the luminescent component will decrease as a function of time, however. This means that the road marking will no longer be sufficiently visible to road users after some time. Providing the present road marking with one or more light sources makes it possible to irradiate the luminescent component at any desired moment, so that the luminescent component will start to emit light anew. It should be noted in this regard that the light source present in the layer must not be confused with the light of a vehicle travelling on the road, or light from street lighting, such as street lamps. In the present road marking, the emission of light by the road marking is no longer related to the light from a vehicle that passes the marking. The presence of one or more light sources in the layer thus causes the luminescent component to be put in an “excited condition” anew, whereupon the luminescent component will start to emit light. According to the inventor, positioning one or more light sources in the layer has made it possible to have the luminescent component emit light for a prolonged period of time and at any desired moment. This will mean that it is possible to make the road marking visible to road users, for example drivers of vehicles travelling on the road, for example during the entire night. With the present road marking it is also possible to have the luminescent component emit no light, in particular by not activating said one or more light sources. This means that it is also possible to realise a low-energy lighting of the road marking. In particularly in low-traffic regions the so-called reactivating of the road marking is a solution that is energetically advantageous because there is no need use stationary lighting, viz. lampposts.

Preferably, said one or more light sources are provided in the profile in such a manner that the luminescent component is positioned above said one or more light sources. In such an embodiment, the one or more light sources are positioned under the luminescent component, which is a good position for putting the luminescent component in a so-called “excited condition”.

The aforesaid translucent material preferably comprises a thermoplastic polymer selected from the group of silicones, polyolefins and elastomers. Such translucent materials are slightly flexible and consequently they can be easily placed in slots or grooves, which slots or grooves are present in the road surface. Usual additives, for example UV stabilisers, may be present in the aforesaid translucent material, insofar as they do not interfere with the translucency of the material.

The profile preferably encloses a cavity, which cavity in particular extends the length of the layer. Such a cavity makes it possible for the road marking to be slightly compressed, so that the installation thereof in a slot or groove is facilitated and the road marking can easily “fill” the space of the slot or groove. This makes it possible to effect a natural clamping of the road marking in such a groove or slot.

In a special embodiment, the profile, also referred to as envelope, preferably encloses a cavity, which cavity is not in communication with the one or more light sources and which in particular extends the length of the layer.

In a special embodiment, the profile is provided with one or more protrusions, so-called barbs, on the circumferential or outer side thereof, which function to help fix the profile in the road surface.

The profile is preferably made up of two separate elements, which can be joined together by means of a snap connection.

Examples of the aforesaid luminescent component include a phosphorus-based compound, in particular comprising zinc sulphide and/or strontium aluminate. Suitable luminescent components thus include, for example, zinc sulphide, strontium aluminate SrAl₂O₄, or derivatives thereof, possibly doped with lanthanides and/or actinides, for example europium.

The invention further relates to the use of tritium (gas) (H₃) as a possible light source for the present road marking, also referred to as reactivatable GITD road lines, viz. the present profile provided with a luminescent component.

It is preferable that the luminescent material is dispersed in the material of the profile as solid particles, in particular that the luminescent component is dispersed in the material of the profile such that the luminescent component is present in a region located near the upper surface of the road marking. The luminescent component is thus present at a position where it can best perform its function, viz. emitting light at the surface. Light-reflecting layers and/or materials may furthermore be present in the envelope.

In the present road marking it is desirable that one or more light sources be provided in the profile with a close fit so as to minimise the ingress of moisture but also dirt.

The preferred light source is a light source of the electroluminescent type.

A road marking is usually embodied in the form of a line or stripe, and consequently it is preferable that the light source to be installed in such a road marking is configured as a tape, wire or ribbon. Using such an embodiment, it has been found to be possible to provide the present road marking with the luminescent component substantially along the length thereof, which component also extends the length of the layer.

As already discussed in the foregoing, it is desirable that the luminescent component be in an “excited condition” in order to be able to subsequently emit light. Because the intensity of the light emitted by the luminescent component will decrease as a function of time, it is desirable, therefore, that the luminescent component be put in the “excited condition” when a specific intensity level is reached. Thus it is preferable that the one or more light sources further comprise means for switching the one or more light sources on and off. Suitable light sources include light sources selected from the group consisting of LED, in particular UV-LED, OLED and electroluminescent (EL) wire and/or tape, or combinations thereof.

The circuit may include a time switch for switching the one or more light sources on and off, which time switch can be pre-set to cause the one or more light sources emit a number of light pulses over a particular period. Such a time switch can thus be programmed for a specific period of time, but it is also possible to use a light-sensitive photocell for said switching on and off.

In a special embodiment of the present road marking, the profile to be installed in the road surface is provided at the upper side thereof with a transparent layer that adds to the skid resistance, in which regard it is in particular desirable that the profile has an overall height such that the upper side thereof is substantially level with the upper surface of the road surface. Using such an embodiment, the present road marking will not project slightly above the road surface, which is found to be undesirable by users of the road, in particular riders of two-wheeled vehicles such as motorcycles. Such a top layer must also be wear resistant and hard. In wintry conditions it must furthermore be able of to withstand contact with snowploughs that remove snow from the roadway.

To effect a satisfactory degree of light emission by the luminescent component whilst also meeting one or more of the aforesaid requirements, it is desirable that the transparent layer that adds to the skid resistance comprise glass beads, glass chippings or a transparent material of synthetic origin. The loss of light intensity is thus minimised and a prolonged usability and durability of the eventual layer is ensured.

The present road marking can be made by means of an extrusion process, for example.

The prefabricated profile or road marking is installed in a groove or slot in a road surface, for example by first applying a layer of an adhesive, for example a bituminous cement, after which the road marking is placed into the groove, possibly by “pinching together” the profile. The aforesaid “barbs” provide an adequate fixation of the profile in the aforesaid groove or slot.

The invention further relates to a road surface provided with one or more road markings as described above.

The present invention will now be explained in more detail by means of an example and with reference to a number of figures, in which connection it should be noted, however, that the present application is by no means limited to such a special example.

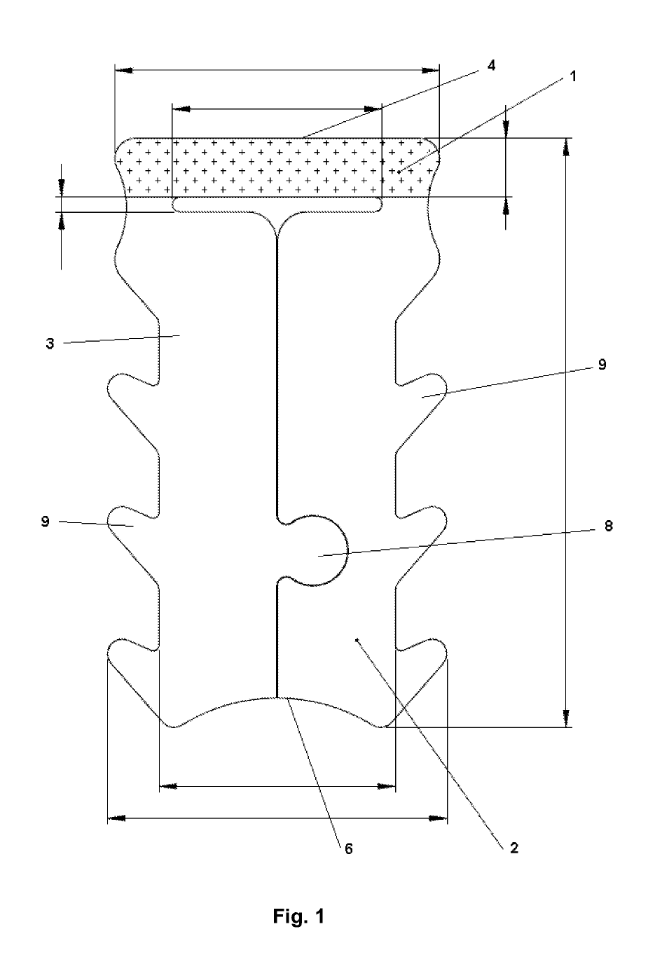

FIG. 1 is a front view of a road marking according to the present invention.

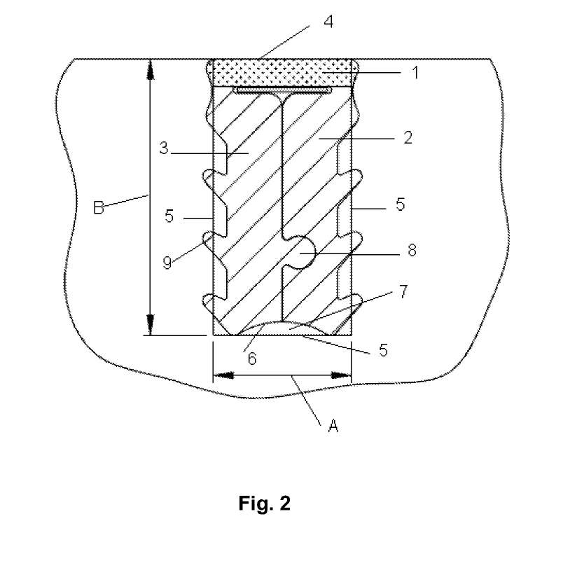

FIG. 2 is a front view of a road marking according to the present invention present in a groove of a road surface.

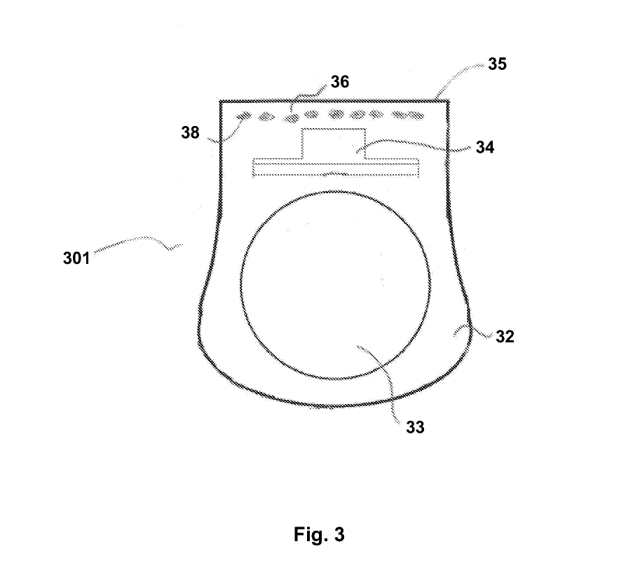

FIG. 3 shows a special embodiment of a road marking according to the present invention.

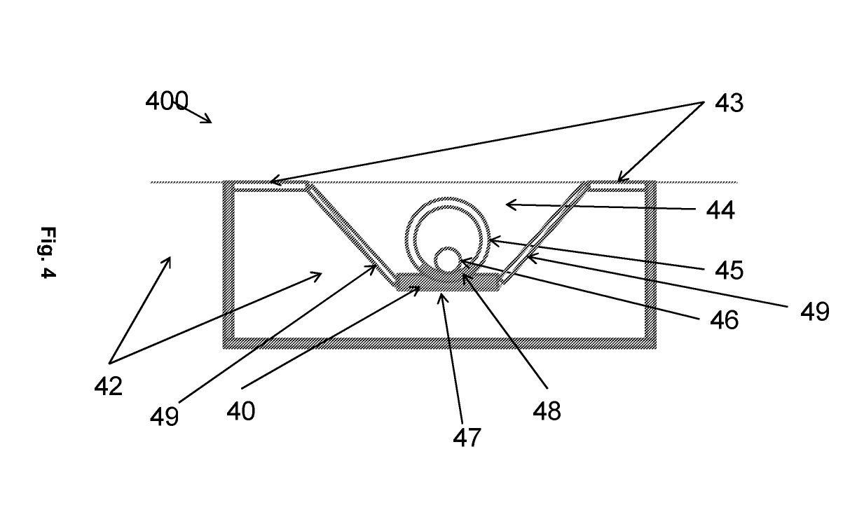

FIG. 4 schematically shows a road marking according to the present invention in a prefabricated module.

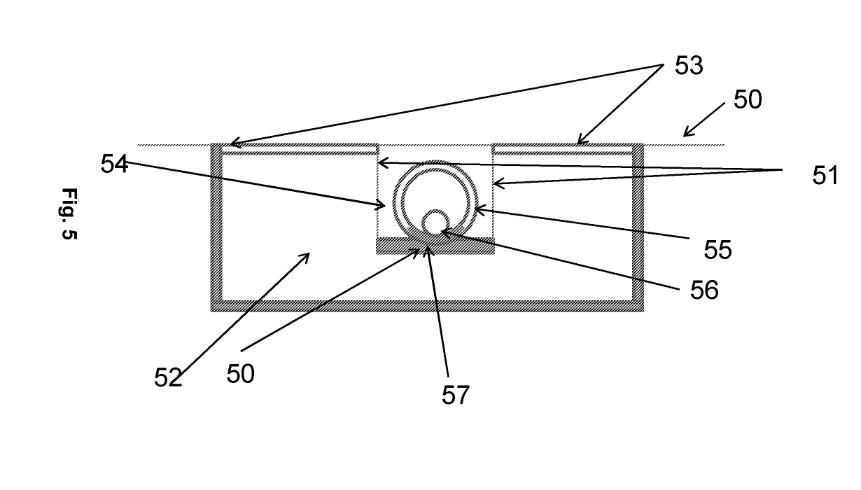

FIG. 5 schematically shows a road marking according to the present invention in a prefabricated module.

The profile of an elastic material preferably comprises two separate elements 2, 3 which are joined together via a snap connection 8 (see FIG. 1). The profile is provided with one or more protrusions, recesses or barbs 9 on the circumferential or outer side thereof. The aforesaid protrusions, recesses or barbs 9 are preferably made of the same material as the profile and function to fix the profile in a groove or slot in the road surface. An amount of pigment (luminescent component) 1 is incorporated at the surface side 4, which pigment emits light in the “excited condition”. It is desirable that the pigment 1 be incorporated in the elastic material of the profile, for example by co-extruding pigment upon forming the profile. Present at the bottom side of the pigment 1, i.e. remote from the surface side, is a light source, for example a light source of the electroluminescent type, the light-emitting surface of which faces upward, toward the upper side.

According to FIG. 2, a groove comprising side walls and a base 5 is provided in an existing road surface. To realise a satisfactory effect of the present invention, it is desirable that the ratio height B:width A of the profile be at least 2:1. The present inventors have found that the profile can be readily incorporated in the road surface with a minimal risk of being “driven out” by passing traffic if the aforesaid condition, viz. a height:width ratio of at least 2:1, is met.

A groove or slot is formed in the road surface, for example by cutting or milling. The profile has a slightly concave bottom side 6 which extends the length of the profile, which bottom side functions as an additional contact surface. The base 5 of the groove thus obtained is preferably first provided with an adhesive layer having a thickness of about 1 mm. On the bottom layer thus provided the profile is placed, the light emitting surface of which faces upward, in the direction of the upper side. A top layer of glass chippings, possibly in combination with an adhesive, on the construction thus provided is not shown for the sake of clarity.

According to FIG. 3, a groove (not shown) having a width of about 10 mm and a depth of about 4-6 mm is formed in an existing road surface (not shown), for example by cutting or milling. The groove thus obtained is first provided with a bottom layer (not shown), for example an adhesive layer having a thickness of about 1 mm. On the bottom layer thus provided, a road marking 301 is placed, which road marking consists of an envelope or profile 32, a tape 34 of a light source of the electroluminescent type, the light emitting surface of which faces upward, in the direction of the upper side 35. Located above the tape 34 thus provided is a luminescent component 38, in a region indicated at 36. The overall structure of the layers thus provided in the groove lies about 0.5 mm below the surface of the road surface, for example. The upper side 5 may also be more or less level with the road surface, however. A top layer of glass chippings, possibly in combination with an adhesive, on the construction thus provided is not shown for the sake of clarity. The dimensions of envelope, without a possible top layer, may be such that the envelope is already level with the road surface, after which the aforesaid top layer is finally provided. In such an embodiment the top layer lies more or less “on top of” the road surface.

FIG. 4 schematically shows a road marking 400 according to the present invention in a so-called prefab module version, in which a groove or slot consisting of sloping walls 49 and a bottom surface 47 is formed in an already existing road marking 43 that is present on the asphalt layer 42.

The aforesaid road marking 43 may be provided before or after the groove is formed. It is also possible to refrain altogether from the use of such a road marking 43 in a prefabricated module and also in the modules yet to be discussed. It should be noted that the present invention is not limited to the presence or absence of such a road marking 43 in any and all of its embodiments.

Disposed in the space formed by the sloping walls 49 and the bottom surface 47 is a translucent envelope 45, in particular a tube of plastic material. The sloping walls 49 include an angle of more than 90° with the surface. Disposed inside said plastic tube 45 is a light source 46, in particular an LED wire. The electrical means needed for controlling the light source 46, which means are obvious to the person skilled in this field, have been left out for the sake of clarity. The transparent tube 45, which is thus present in the aforesaid groove, is surrounded by a translucent resin material 44, with the translucent resin material 44 in the aforesaid groove or slot preferably being level with the upper surface of the asphalt layer 42, which upper surface is in fact indicated by the existing marking 43. The translucent resin 44 material preferably comprises a luminescent component. An adhesive 40 is used in order to obtain an adequate fixation of the envelope 45 to the bottom surface 47. It is further indicated in FIG. 4 that a part of the transparent tube 45 is provided with a reflecting surface 48 at the bottom side, which surface 48 causes light emitted by the LED wire 46 to be reflected upward, so that a good light yield is obtained. It is also possible to provide the translucent resin material 44 with glass beads, for example, so that an improved visibility of the present road marking 400 is obtained. The space between the housing, which housing is indicated by the bolder lines, the road marking 43, the sloping walls 49 and the bottom surface 47 is preferably provided with asphalt as the filling material. The present invention is not limited to such a prefabricated module; it can also be installed in the road surface without making use of the aforesaid housing.

FIG. 5 shows another embodiment of the present road marking 50 in the form of a prefabricated module, in which the groove formed in the asphalt layer 52 now has upright walls 51 instead of sloping walls 49 (see FIG. 4) and a bottom surface 57. An adhesive 50 is applied to the bottom surface 57 for fixing the translucent tube 55 in the aforesaid groove, by means of which adhesive the translucent tube 55, in which an LED wire 56 is present, is advantageously positioned on the bottom surface 57. The electrical means needed for controlling the light source 56, which means are obvious to a person skilled in this field, have been left out for the sake of clarity. The groove formed by the upright walls 51 and the bottom surface 57 is filled with a translucent resin material 54. The translucent resin material 54 preferably comprises a luminescent component. The walls 51 and the bottom surface 57 may be provided with a reflecting layer. The level of the translucent resin material 54 in the aforesaid groove is such that a substantially flat surface is obtained on the asphalt layer 52. The space between the housing, which housing is indicated by the bolder lines, the road marking 53, the walls 51 and the bottom surface 57 is preferably provided with asphalt as the filling material. The present invention is not limited to such a prefabricated module; it can also be installed in the road surface without making use of the aforesaid housing.

In a special embodiment (not shown), the sloping walls 49 in the road marking are configured so that the sloping walls 49 of the groove extend at an angle relative to the bottom surface 47, such that the width of the bottom surface 47 is greater than the width of the groove at surface level. In such an embodiment, the sloping walls include an angle of less than 90° with the surface.

The electroluminescent light source, preferably in the form of a tape, is provided with current supply wires, which are connected to a power box. By applying a voltage to the light source, the light source will start to emit light, as a result of which the luminescent component will reach the “excited condition”. After some time, the light source is switched off, and the luminescent component will start to emit light of its own accord. After some time, the intensity of the emitted light will have decreased to a particular level, whereupon the light source is switched on by re-applying a voltage, as a result of which the luminescent component will be reactivated by the light from the light source. Such a cycle of switching the light source on and off can take place according to any schedule that may be desired.

According to the present invention it is thus possible to produce a road marking which will be permanently visible, independently of light from a driver of a vehicle travelling on the roadway, with reactivation of the luminescent component taking place as needed, in particular as a result of the presence of one or more light sources, which light sources can be controlled at any moment and for any period of time that may be desired.

It is furthermore desirable that the profile be made of an elastic material. In the case of a profile which is slightly wider than the saw cut into which the profile is to be placed, it must be possible to pinch the profile together in order to be able to place the profile into the saw cut, and as a result of the profile attempting to return to its original shape, a force will be exerted on the side wall of the saw cut. The profile must be designed so that a sufficiently large pressure will be exerted on the side of the saw cut for fixing the profile in position in the saw cut in the case of loads being applied thereto by traffic and in the case of loads caused by expansion and shrinkage due to temperature changes. The profile must preferably be designed so that space is available at the bottom side, where the profile meets the bottom of the saw cut, for accommodating a possible cement bead that is applied as additional security for fixing the profile in position. Space must be available on the side of the profile for receiving any excess cement. Said excess material provides additional fixation. It is also desirable that cavities be present in the profile, in which cavities an electroluminescent strip and possibly also the energy supply in the form of batteries as well as the control unit can be accommodated. A heating wire may additionally be incorporated in the profile so as to ensure that the line will be visible also when the road is covered with snow.

The profile, in any case the upper few mm thereof, is preferably made of a transparent or translucent material, so as to transmit light. A “glow in the dark” pigment is incorporated in the compound of the upper layer in an amount such that light will be able to reach and charge all the particles. Instead of an electroluminescent strip, it is also possible to incorporate an electroluminescent layer of the same material as the rest of the profile in the extrusion process, so that the risk of a short-circuit is reduced. The profile is preferably made of silicone, because of its high UV resistance, translucency, elasticity and flexibility.

An adequate protection against the ingress of moisture is preferably realised by extending the closing distance in the form of a snap connection. Furthermore, the fixation against the side wall of the saw cut is realised by providing “barbs”. Said barbs must turn over when the profile is pulled out of the saw cut. This creates an additional pressure, which makes said pulling out more difficult.

According to another clamping method, use is made of a hollow space which is compressed upon installation and which subsequently presses against the saw cut. The electroluminescent tape (EL tape) can preferably be switched (on/off, intensity, period) both by remote control and in situ (wired/non-wired). Other embodiments comprise: a sensor in the strip (light, presence, temperature, moisture), RFID in the strip for individual switching of the lines, other light colours (filter or material), a variable filling degree of the pigment material in the profile material, changing the colour during dusk/night transition, mounting a battery in/under the road surface. Preferably, the profile can be moulded in (bitumen/epoxy), in particular for applications where clamping does not suffice. Other possibilities include a dirt-repellent coating on the top layer and a special sawtooth profile in the asphalt for a clamping, non-glued fixation in the road surface. It is also possible to use a following function, viz. a switchable line in length of segment, length of time, speed, intensity and colour. The use of induction loops in the roadway, in which the iron mass of a car driving by generates a small current in a coil that is used as sensor current for turning the light line on and/or charging the battery of the light line in the road. As regards the extrusion process, the following possibilities are mentioned: integrating EL in the silicone profile, integrating a battery in the silicone profile, integrating solar cells in the silicone profile, integrating means that add to the skid resistance in the silicone profile. It is also possible to position a white line in or beside the present road marking, viz. the present profile, in connection with the visibility in particular during the daytime. Another aspect is the fact that the present pigment can function as a UV blocker for the EL layer, which generally is not UV resistant. Profiling of the upper layer is possible, so that the visibility of the present road marking is further enhanced.

The power supply for the supporting light source may also be embodied as a wired power supply. The connection is preferably made watertight by moulding the connections and the supply wire in liquid silicone paste. The wiring is led to the bottom side of the road in a slot in the road surface or via a borehole, and connected beside the road.

1. A road marking comprising a profile comprising a luminescent component, which is to be installed in the road surface, in which profile one or more light sources are present and the aforesaid luminescent component is located above said one or more light sources, characterised in that the profile is made of an elastic material, wherein the part of the profile present at the surface of the road surface is translucent.

2. A road marking according to claim 1, characterised in that said material comprises a thermoplastic polymer selected from the group of silicones, polyolefins and elastomers.

3. A road marking according to claim 1, characterised in that said profile encloses a cavity, which cavity extends the length of the profile.

4. A road marking according to claim 1, characterised in that said luminescent component is a phosphorus-based compound, in particular comprising zinc sulphide and/or strontium aluminate, preferably zinc sulphide, strontium aluminate SrAl₂O₄, or derivatives thereof, possibly doped with lanthanides and/or actinides, for example europium.

5. A road marking according to claim 1, characterised in that said luminescent material is dispersed in the material of the profile as solid particles

6. A road marking according to claim 5, characterised in that said luminescent component is dispersed in the material of the profile such that said luminescent component is present in a region located near the upper surface of the road marking.

7. A road marking according to claim 1, characterised in that the one or more light sources are provided in the profile with a close fit.

8. A road marking according to claim 1, characterised in that the one or more light sources are of the electroluminescent type, in particular are configured as a tape, wire or ribbon.

9. A road marking according to claim 1, characterised in that the one or more light sources are of the UV-LED type.

10. A road marking according to claim 1, characterised in that the one or more light sources extend the length of the profile.

11. A road marking according to claim 1, characterised in that the one or more light sources further comprise means for switching the one or more light sources on and off, in particular a time switch.

12. A road marking according to claim 11, characterised in that the means for switching on and off comprise a light-sensitive photocell.

13. A road marking according to claim 1, characterised in that the profile to be provided in or on the road surface is provided at the upper side thereof with a transparent layer that adds to the skid resistance, which upper side is level with the road surface.

14. A road marking according to claim 13, characterised in that the transparent layer that adds to the skid resistance comprises glass beads.

15. A road marking according to claim 1, characterised in that the profile is provided with one or more protrusions on the outer side thereof, which function to help fix the profile in the road surface.

16. A road marking according to claim 1, characterised in that the profile is made up of two separate elements, which can be joined together by means of a snap connection.

17. A road marking according to claim 1, characterised in that the ratio height B:width A of the profile is at least 2:1.

18. A road marking according to claim 1, characterised in that the profile is installed in a groove in the road surface, wherein the walls and/or the bottom surface of said groove are provided with a light-reflecting material.

19. A road marking according to claim 18, characterised in that the walls of the groove extend at an angle relative to the bottom surface, such that the width of the bottom surface is greater than the width of the groove at surface level.

20. A road marking according to claim 18, characterised in that the walls of the groove extend at an angle relative to the bottom surface, such that the width of the groove at the surface level thereof is greater than the width of bottom surface.

21. A road marking according to claim 18, characterised in that the bottom surface of the groove is provided with an adhesive.

22. A road surface provided with one or more road markings according to one or more of the preceding claim 1.
